(19) United States
(12) Patent Application Publication
(10) Pub. No.: US 2025/0062517 A1
(43) Pub. Date: Feb. 20, 2025

(54) COVER AND A CAVITY FILTER COMPRISING THE SAME

(71) Applicant: Telefonaktiebolaget LM Ericsson (publ), Stockholm (SE)

(72) Inventors: Weidong Wang, Beijing (CN); Xueyuan Zhang, Beijing (CN); Lei Sun, Beijing (CN); Bingjian Niu, Beijing (CN); Jun Fu, Beijing (CN)

(21) Appl. No.: 18/725,868

(22) PCT Filed: Jan. 4, 2022
(86) PCT No.: PCT/CN2022/070136

§ 371 Date: Jul. 1, 2024

(51) Int. Cl. H01P 1/202; H01P 7/04

(52) U.S. Cl. CPC H01P 1/202; H01P 7/04

(57) ABSTRACT

The present disclosure relates to a cover for a cavity filter, comprising a cover body made of plastic and an inner metal layer applied on an inner side of the cover that is in contact with a cavity of the cavity filter, wherein a capacitance-influencing structure is provided on the inner side of the cover and comprises a recess formed in the cover body and/or a protrusion integrally formed with a base of the cover body and/or a non-metallized area in the inner metal layer. The present disclosure also relates to a cavity filter comprising the above-said cover.

### TECHNICAL FIELD

The present disclosure generally relates to the technical field of a filter and, more particularly, to a cover for a cavity filter and a cavity filter comprising the same.

### BACKGROUND

This section introduces aspects that may facilitate better understanding of the present disclosure. Accordingly, the statements of this section are to be read in this light and are not to be understood as admissions about what is in the prior art or what is not in the prior art.

With the development of 5G communication technology, MIMO (multiple-input and multiple-output) technology is widely used, which requires a lot of filter units (FUs) to be integrated with an antenna unit (AU) or a radio unit (RU). Filters that are smaller and lighter with better performance are quite in demand.

In the traditional solution, metal filters are used widely in view that they can be made light. In a sheet metal filter, a sheet metal cover uses tabs integrally formed thereon to realize a tuning function, so that tuning screws can be dispensed with and more space can be saved for the cover. However, the sheet metal cover does not have sufficient strength. It may be unreliable due to a long term of deformation created in the tabs thereon during the tuning process and thus has a high risk of changing performance. Furthermore, manual efforts are needed for the tuning in this kind of metal filter, resulting in low efficiency and instability in terms of performance. Since the metal filter is made of one single metal material, it is hard to solve the problem of temperature drift in single cavity design. Also, traditional ceramic waveguide filters have limited applications due to its limited band width.

Plastic filters are attracting more attentions for they can be made light because of the low density in plastic. However, in existing plastic filters, their thermal conductivity is too poor to dissipate the heat generated in its resonance cavity and the tuning screws penetrating through the cover made of plastic occupy much space above the cover plate and their tuning process is still time-consuming, having a low efficiency. For a plastic filter in big volume, it is hard to make thermal expansion coefficients consistent in both longitudinal and transversal directions and also difficult to compensate for temperature drift in such a filter.

In view of the above, there is a need in developing a cavity filter which may be able to overcome one or more of the above-said problems.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

The present disclosure aims to provide a cover for a cavity filter, which allows to reduce weight and volume of the entire filter and improve in terms of mechanical strength and/or tuning efficiency.

According to a first aspect of the disclosure, there is provided a cover for a cavity filter, comprising a cover body made of plastic and an inner metal layer applied on an inner side of the cover that is in contact with a cavity of the cavity filter. A capacitance-influencing structure is provided on the inner side of the cover and comprises a recess formed in the cover body and/or a protrusion integrally formed with a base of the cover body and/or a non-metallized area in the inner metal layer.

In an embodiment of the disclosure, the capacitance-influencing structure comprises the recess or the protrusion that faces a resonator in the cavity and/or comprises the protrusion that extends into a space between two adjacent resonators in the cavity.

In an embodiment of the disclosure, the capacitance-influencing structure comprises a first frequency-tuning means which is configured as a variable non-metallized area selectively provided in the inner metal layer or on the recess or the protrusion facing a resonator in the cavity such that a variable plastic dielectric loading is obtained for the resonator.

In an embodiment of the disclosure, an outer metal layer is applied on an outer side of the cover, and a second frequency-tuning means is provided on the outer side of the cover and configured as a variable non-metallized area that is selectively provided in the outer metal layer and located in a region opposite to the first frequency-tuning means.

In an embodiment of the disclosure, the capacitance-influencing structure comprises a main coupling-tuning means which is configured as a variable non-metallized area selectively provided on the protrusion that extends into a space between two resonators in the cavity of the cavity filter.

In an embodiment of the disclosure, the capacitance-influencing structure comprises a cross coupling-tuning means which is configured as a variable non-metallized area selectively provided in the inner metal layer or on the recess or the protrusion such that cross coupling associated therewith is varied accordingly.

In an embodiment of the disclosure, the cross coupling-tuning means comprises a cross negative coupling-tuning means or a cross positive coupling-tuning means.

In an embodiment of the disclosure, the variable non-metallized area is formed or varied by laser etching or grinding.

In an embodiment of the disclosure, the capacitance-influencing structure comprises an isolation shielding means that is integrally formed with the base of the cover body as a rib or a grid protruding into the cavity of the cavity filter.

In an embodiment of the disclosure, the capacitance-influencing structure comprises a cross coupling means integrally provided on the isolation shielding means.

In an embodiment of the disclosure, the capacitance-influencing structure comprises a positive coupling means configured in the form of an aperture or a hole provided in the isolation shielding means.

In an embodiment of the disclosure, the cover body is made by plastic injection molding.

In an embodiment of the disclosure, different portions of the cover body are made from different kinds of plastic material with different thermal expansion coefficients.

According to a second aspect of the disclosure, there is provided a cavity filter comprising at least one resonator disposed in its cavity, wherein it comprises a cover as stated in the above.

In an embodiment of the disclosure, the cavity filter comprises a metal housing that is covered by the cover, and a closed cavity is defined by the housing and the cover for housing the at least one resonator.

The present disclosure thus provides a cavity filter by using plastic material with less density than metal for its cover part and using metal for its bottom housing part. The use of plastic with certain thickness and hardness makes the cover of the filter have certain rigidity, which improves the resistance against deformation of a miniaturized filter product during production, transportation and assembly and thus greatly increases the reliability of the filter product. And the housing made of metal can facilitate in dissipating heat from the resonators. Furthermore, it enables using plastic materials with different thermal expansion coefficients for different portions of the cover of the filter by changing its composition, which provides another choice for realizing temperature compensation in a single-cavity design of a miniaturized filter.

It also provides a new way of tuning by means of a laser etching method or polishing/grinding technology. The number of components for a filter can be largely reduced. The absence of tuning screws also helps to reduce the weight and volume of the filter. And the structure of the filter is made simpler than that of traditional metal filter.

Also, with the first or second frequency tuning means of the present disclosure, plastic dielectric loading can be achieved accordingly, so that the frequency of the cavity associated therewith can be reduced further and the size of the cavity filter can be made smaller than that of an existing cavity filter for a same range of frequency. Therefore, improved filter performance can be obtained with reduced weight and volume.

In the cavity filter of the present disclosure, coupling structures are formed at the same time of manufacturing the cover, which makes the cross-coupling easier to be controlled. Negative coupling and positive coupling can be established, routed and placed in a more flexible manner. The flexibility in design also benefits the application in a macro station with reduced cost.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is an exploded view of a cavity filter according to a first embodiment of the present disclosure;

FIG. 2 is a bottom view of the cover for the cavity filter of FIG. 1;

FIG. 3 is a top view of the cover for the cavity filter of FIG. 1;

FIG. 4 shows a bottom view of a cover according to a second embodiment of the present disclosure; and

FIG. 5 shows a bottom view of a cover according to a third embodiment of the present disclosure.

### DETAILED DESCRIPTION

The embodiments of the present disclosure are described in detail with reference to the accompanying drawings. It should be understood that these embodiments are discussed only for the purpose of enabling those skilled in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. Those skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

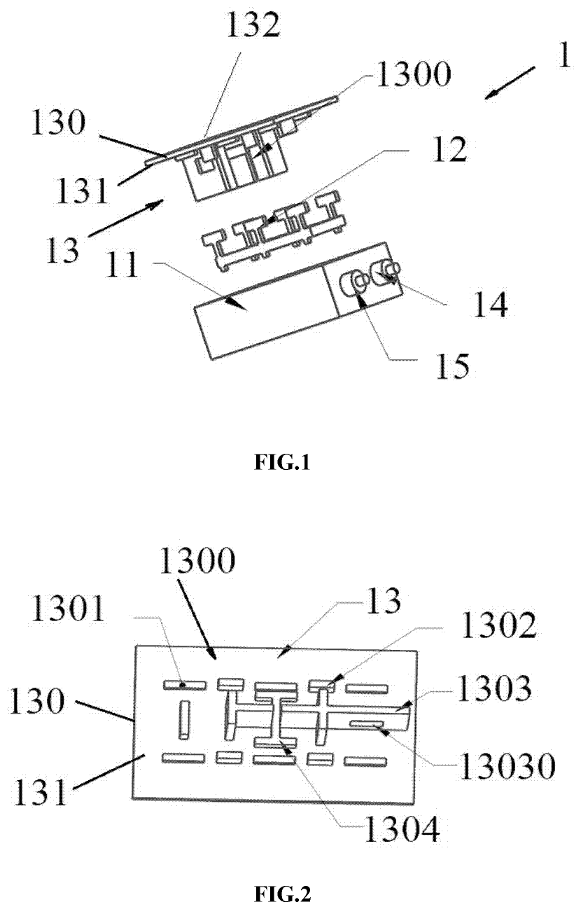

FIG. 1 shows an exploded view of the cavity filter 1 of the present disclosure. The cavity filter comprises a housing 11 with an upper opened end and a cover 13 attached to the housing and close the upper opening of the housing, so that a closed cavity is defined by the cover and the housing together. Resonators 12 are housed in the cavity. Input terminal 14 and output terminal 15 are connected to an interior of the cavity for signal transmission. Although it is shown that the cover is configured in the form of a plate, it can be understood that the cover may be shaped as a box-like shell with a bottom opened end which is to be closed by a plate-like bottom housing.

In the embodiment of the present disclosure, the housing 11 may be made of metal. For example, the housing may be made in one piece by casting, or manufactured by connecting metal components together by welding. Similarly, resonators 12, as a main structure for signal transmission, may be made in one piece by casting, or manufactured by assembling metal components and having them connected by welding.

The cover 13 comprises a cover body 130 made of plastic, for example, by plastic injection molding. The cover is also provided with an inner metal layer 131 applied on an inner side of the cover, for example, by a surface metallization method, such as plating. The inner side of the cover is in contact with the cavity of the cavity filter when the cover is positioned in place. By the metal layer applied on the inner side of the cover, the cover 13 may be readily put into a state of grounding connection when it is attached to the housing 11.

As shown in FIG. 1, a capacitance-influencing structure 1300 is provided on the inner side of the cover and comprises a recess formed in the cover body and/or a protrusion integrally formed with a base of the cover body and/or a non-metallized area in the inner metal layer 131. The recess and/or protrusion may have their surfaces partially or fully metalized so that they may function in a desired manner.

Hereinbelow, the term “capacitance-influencing structure” refers to all the structure or means that may influence the capacitance with resonators or between resonators in the cavity of the cavity filter. For example, it may be embodied as a frequency tuning means, a main coupling means or a main coupling tuning means, a cross coupling means or a cross coupling tuning means, an isolation shielding means or a positive/negative coupling means, or any combination thereof.

In an embodiment of the present disclosure, the capacitance-influencing structure 1300 may comprise the recess or the protrusion that faces a resonator in the cavity. A distance between a resonance end of the resonator and a surface of the recess or protrusion that faces the resonance end of the resonator is kept as an interval for creating capacitance therebetween. The recess or protrusion may be designed to have an appropriate concave depth or protrusion length such that an appropriate capacitance may be obtained. Alternatively or optionally, the capacitance-influencing structure 1300 may comprise the protrusion that extends into a space between two adjacent resonators in the cavity of the cavity filter. The protrusion looks like a stationary “coupling screw” and functions to impose an influence on the capacitance between the two resonators and therefore the coupling therebetween.

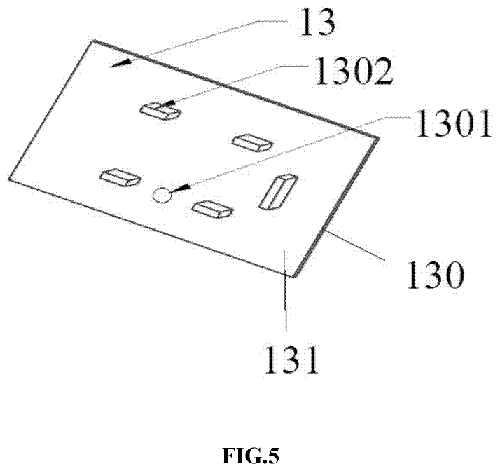

Specifically, referring to FIG. 2, the capacitance-influencing structure 1300 comprises a first frequency-tuning means 1301 which is configured as a variable non-metalized area selectively provided in the inner metal layer 131 or on the recess or the protrusion facing a resonator in the cavity, such that a variable plastic dielectric loading is obtained for a target resonator in the cavity of the cavity filter. In an embodiment according to the present disclosure, for the purpose of tuning frequency, the non-metallized area may be selectively provided on the inner side face of the cover facing the target resonator, and varied in terms of size or shape or area, for example, by removing metal from the metal layer applied thereon or applying metal onto an exposed region of the cover body. The non-metallized area may be provided on the recess, or on the protrusion, as shown in FIGS. 2 and 4, or simply by an exposed non-metalized region of the cover body, as shown in FIG. 5. In case where the non-metallized area is located on a protrusion extending from the cover 13 into the cavity and facing a resonator, the protrusion looks like a tuning “screw”, but a tuning process adopted therefor is to change the non-metallized area on the protrusion (that is, by varying size or shape or location of the non-metallized area and thus changing the metallization characteristics and therefore obtaining variable plastic dielectric loading in connection with the resonator concerned). By means of variation of plastic dielectric loading achieved, the capacitance between the face of the cover where the non-metallized area is located and the target resonator is increased, thus making it possible that the frequency of the cavity where the target resonator is located can be reduced further and the size of the cavity filter can be made smaller.

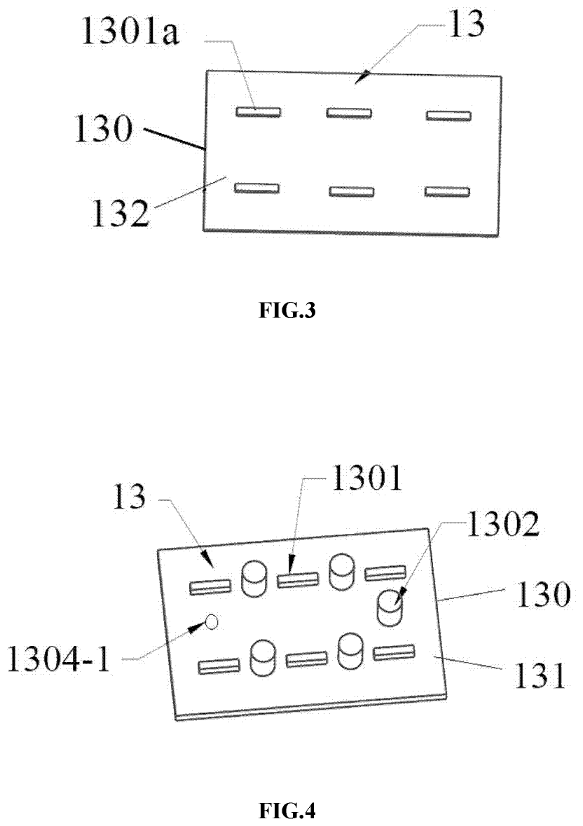

In an embodiment of the present disclosure as shown in FIG. 3, an outer metal layer 132 is applied on an outer side of the cover 13 that faces away from the cavity, and a second frequency-tuning means 1301a may be provided on the outer side of the cover and configured as a variable non-metalized area that is selectively provided in the outer metal layer 132 and located in a region opposite to the first frequency-tuning means 1301. This embodiment provides an additional measure for frequency tuning, which is easy to implement with high efficiency and improved reliability.

Still referring to FIG. 2, the capacitance-influencing structure 1300 comprises a main coupling-tuning means 1302 which is configured as a variable non-metallized area selectively provided on a protrusion that is integrally formed with the base of the cover body 130 and extends into a space between two adjacent resonators in the cavity of the cavity filter. The main coupling between two resonators 12 can thus be adjusted by varying the size or shape or location of the non-metalized area on corresponding coupling face or faces on the protrusion with respect to the two adjacent resonators. In the embodiments shown in FIGS. 2 and 5, the protrusion for the main coupling-tuning means 1302 is made substantially in a regular cuboid shape. In this case, the main coupling-tuning means can be provided on the faces of the protrusion facing a resonator on each side. Of course, it is also possible that the main coupling-tuning means 1302 can be provided on a protrusion made in a columnar or cylinder-like shape, as shown in FIG. 4.

In an embodiment of the present disclosure, the capacitance-influencing structure 1300 may further comprise a cross coupling-tuning means 1304-1 which is configured as a variable non-metallized area selectively provided in the inner metal layer or on the recess or the protrusion such that cross coupling associated therewith is varied accordingly. As shown in FIG. 4, the cross coupling-tuning means 1304-1 is provided as an exposed non-metalized area of the base of the cover body directly. By changing the location or shape of the exposed non-metalized area, the cross-coupling strength may be changed accordingly. According to a specific arrangement of the resonators, the cross coupling-tuning means may be located on a recess or protrusion integrally formed on the inner side of the cover in a position between two resonators belonging to different resonance cavities. The cross coupling-tuning means may comprise a cross negative coupling-tuning means or a cross positive coupling-tuning means.

All the above tuning means in the form of a non-metalized area may be formed or varied in terms of size or shape or location, by laser etching or grinding. Thus, the tuning process involved can be performed by means of an automation technology and the tuning efficiency can be greatly improved. It may help to meet the needs of the filter tuning in batch production.

In the embodiment shown in FIG. 2, the capacitance-influencing structure 1300 may comprise an isolation shielding means 1303 that is integrally formed with the base of the cover body as a rib or a grid protruding into the cavity of the cavity filter. A cross coupling means 1304 is integrally provided on the isolation shielding means 1303. A cross coupling tuning means may be selectively provided on the cross coupling means 1304. That is, a selective surface metallization method may be applied to change the metallization state of the cross coupling means 1304 and therefore the cross coupling associated therewith.

Still referring to FIG. 2, the capacitance-influencing structure 1300 may further comprise a positive coupling means 13030 configured in the form of an aperture or a hole provided in the isolation shielding means 1303.

FIGS. 2-4 show some embodiments of the capacitance-influencing structure. It can be understood that the capacitance-influencing structure provided on the inner side of the cover may be configured differently, for example, by comprising at least one of or any combinations of the frequency-tuning means, main coupling means, main coupling tuning means, cross coupling means, cross coupling tuning means, cross positive/negative coupling means and isolation shielding means.

According to the present disclosure, the cover 13 may be attached to the housing 11 by a reflow soldering, with the capacitance-influencing structure being in contact with or being housed in the cavity and interacting with the resonators therein.

Hereinbelow, the terms “top”, “bottom”, “upper”, “lower” are introduced just for the sake of describing the relative positions of parts when the cavity filter is placed in a manner as shown in FIG. 1. None of them should be interpreted as limitative for the arrangement of the cavity filter or its elements. The terms “inner” and “outer” are used to refer to the sides of the cover or the cover body with respect to the interior of the cavity of the cavity filter when the cavity filter is well assembled.

As stated in the above, the cover body may be made, by plastic injection molding, into one piece to have recesses or protrusion thereon. Then the inner side of the cover body is subject to a surface metallization treatment. Frequency-tuning means or main coupling tuning means or cross-coupling tuning means may be selectively provided on the inner side of the cover. When the cover is attached to the housing and positioned in place, all the means may function as a whole to influence the capacitance relevant to the resonators in the cavity in a desired manner. Another frequency-tuning means may also be selectively provided on the outer side of the cover so as to have the frequency tuned further.

In the present disclosure, the cross-sectional shape of the recesses or protrusions of the capacitance-influencing structure can be, for example, rectangular or circular or in any other regular or irregular geometries. By having a recess or a flat surface of the cover body provided for the provision of non-metalized area, weight of the filter can be reduced, and for a cover with protrusions integrally provided therein, structural strength of the cover can be enhanced thereby.

For solving the problem of temperature drift, different portions of the cover body are made from different kinds of plastic material with different thermal expansion coefficients. The thermal expansion coefficients of the plastic cover can be adjusted by changing its material formulation, which provides an option for temperature compensation for miniaturized single-cavity designs.

For a cavity filter of the present disclosure comprising a plastic cover part and a metal housing part, it may make full use of the metal housing part to obtain excellent thermal dissipation and meanwhile adopt the plastic cover part to obtain high structural strength and improved tuning efficiency and reliability and reduce the weight and size of the cavity filter.

Specifically, as compared with an existing metal filter consisting of both a metal cover part and a metal housing part, the cavity filter of the present disclosure can be made lighter, smaller, more robust and simpler in structure and also the tuning process is easy to be conducted by means of robots with high efficiency, improved precision and reliability, and allows to dispense with coupling screws or tuning screws or tuning tabs which necessarily result in formation of openings/apertures on the cover and therefore signal leakage caused thereby.

As compared with an existing plastic filter consisting of both a plastic cover part and a plastic housing part, the cavity filter of the present disclosure can get rid of tuning screws or coupling screws and thus occupy much less space above the entire filter. Signal leakage caused by the presence of tuning screws or coupling screws can be avoided as well. Also, the cavity filter of the present disclosure has an advantage over the existing plastic filter in terms of production and/or assembling efficiency, thermal dissipation and tuning efficiency. Furthermore, the problem of temperature drift that exists in the existing plastic filter can be solved or eliminated according to the present disclosure, by adoption of a metal housing part and optionally by changing material formulations for different portions of the plastic cover part.

References in the present disclosure to “an embodiment”, “another embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A cover for a cavity filter, comprising a cover body made of plastic and an inner metal layer applied on an inner side of the cover that is in contact with a cavity of the cavity filter, wherein a capacitance-influencing structure is provided on the inner side of the cover and comprises a recess formed in the cover body and/or a protrusion integrally formed with a base of the cover body and/or a non-metallized area in the inner metal layer.

2. The cover according to claim 1, wherein the capacitance-influencing structure comprises the recess or the protrusion that faces a resonator in the cavity and/or comprises the protrusion that extends into a space between two adjacent resonators in the cavity.

3. The cover according to claim 1, wherein the capacitance-influencing structure comprises a first frequency-tuning means which is configured as a variable non-metallized area selectively provided in the inner metal layer or on the recess or the protrusion facing a resonator in the cavity such that a variable plastic dielectric loading is obtained for the resonator.

4. The cover according to claim 3, wherein an outer metal layer is applied on an outer side of the cover, and a second frequency-tuning means is provided on the outer side of the cover and configured as a variable non-metallized area that is selectively provided in the outer metal layer and located in a region opposite to the first frequency-tuning means.

5. The cover according to claim 1, wherein the capacitance-influencing structure comprises a main coupling-tuning means which is configured as a variable non-metallized area selectively provided on the protrusion that extends into a space between two resonators in the cavity of the cavity filter.

6. The cover according to claim 1, wherein the capacitance-influencing structure comprises a cross coupling-tuning means which is configured as a variable non-metallized area selectively provided in the inner metal layer or on the recess or the protrusion such that cross coupling associated therewith is varied accordingly.

7. The cover according to claim 6, wherein the cross coupling-tuning means comprises a cross negative coupling-tuning means or a cross positive coupling-tuning means.

8. The cover according to claim 1, wherein the variable non-metallized area is formed or varied by laser etching or grinding.

9. The cover according to claim 1, wherein the capacitance-influencing structure comprises an isolation shielding means that is integrally formed with the base of the cover body as a rib or a grid protruding into the cavity of the cavity filter.

10. The cover according to claim 9, wherein the capacitance-influencing structure comprises a cross coupling means integrally provided on the isolation shielding means.

11. The cover according to claim 9, wherein the capacitance-influencing structure comprises a positive coupling means configured in the form of an aperture or a hole provided in the isolation shielding means.

12. The cover according to claim 1, wherein the cover body is made by plastic injection molding.

13. The cover according to claim 12, wherein different portions of the cover body are made from different kinds of plastic material with different thermal expansion coefficients.

14. A cavity filter comprising at least one resonator disposed in its cavity, wherein it comprises a cover comprising a cover body made of plastic and an inner metal layer applied on an inner side of the cover that is in contact with a cavity of the cavity filter, wherein a capacitance-influencing structure is provided on the inner side of the cover and comprises a recess formed in the cover body and/or a protrusion integrally formed with a base of the cover body and/or a non-metallized area in the inner metal layer.

15. The cavity filter according to claim 14, wherein the cavity filter comprises a metal housing that is covered by the cover, and a closed cavity is defined by the housing and the cover for housing the at least one resonator.
